(19) United States
(12) Patent Application Publication
(10) Pub. No.: US 2002/0023000 A1
(43) Pub. Date: Feb. 21, 2002

(54) Displaying as a map and graphs on a web page the geographical distribution of visitors that click on banner ads in cyberspace

(76) Inventor: Denison W. Bollay, Santa Barbara, CA (US)

Correspondence Address: Owen L. Lamb, PO Box 240, Santa Barbara, CA, 93102-0240, US

(21) Appl. No.: 09/895,495

(22) Filed: Jun. 28, 2001

Related U.S. Application Data
(60) Provisional application No. 60/226,053, filed on Aug. 16, 2000.

(51) Int. Cl. G06F 17/60

(52) U.S. Cl. 705/14

(57) ABSTRACT

A server places ads on a public web page accessible to Internet visitors. The ads are placed in accordance with an ad campaign strategy of an advertiser. Data that includes ad impressions, IP addresses of visitors and geographical data including locations of IP addresses of the visitors are supplied to a servlet. The servlet separates the enhanced data into site-specific data and advertiser-specific data. The site-specific data and a site-specific applet are transferred to a private web page accessible to the site. The site-specific applet dynamically plots indicia representing ad impressions for a site included in the site-specific data on a map on the private web page accessible to the site. The advertiser-specific data and an advertiser-specific applet are transferred to a private web page accessible to the advertiser. The advertiser-specific applet dynamically plots indicia representing ad impressions for the advertiser included in the advertiser-specific data on a map on the private web page accessible to the advertiser. A visual characteristic (color, size, intensity etc.) of an indicium is changed in proportion to a number of the Internet visitors from the same geographical location.

### CROSS-REFERENCE TO RELATED APPLICATIONS

This application is related to application Ser. No. 60/226053 filed Aug. 16, 2000, entitled “Network For Matching Internet Banner Ad View With An Internet Advertiser” and to application Ser. No. 09/274,984 filed Mar. 25, 1999, entitled “A Method Of Real-time Allocation Of Ad Space On A Web Page Based On A Bidding Protocol”, which applications are assigned to ExperClick, Inc., the assignee of the present invention and are incorporated herein by reference.

### BACKGROUND OF THE INVENTION

1. Field of the Invention

This invention relates to a method of displaying, as a map and a series of graphs on a web page, information about visitors to web pages on the Internet, or viewers of streaming video, for the purpose of monitoring, in real-time, the geographical distribution of visitors viewing advertisements in cyberspace.

2. Description of the Prior Art

Advertisers on the Internet advertise their products and services in web page banner ads that are graphical representations of products and services being offered. When someone browsing a web page clicks on an ad, a link causes a transfer to a web site of the sponsor of the ad. Web sites may allow advertisers to advertise on web pages that fit an advertisers particular category and charge the advertiser for the advertising space.

Cyberspace is the total of people communicating with each other via computers without regard to physical geography. Since web sites are in cyberspace, an advertiser does not know where in the physical world a banner ad is being viewed. In the physical world a roadside billboard ad is known to be in a specific geographical location. The advertiser knows that motorists traveling on a particular road can view the billboard ad; therefore the ads can be targeted to a particular geographical location. In cyberspace, a banner ad can be viewed from anywhere in the world and with current technology cannot be targeted to a particular geographical location.

It is desirable that an advertiser on the Internet knows where in the physical world a particular banner ad is being viewed. It is also desirable that an advertiser be able to determine that visitors to the Internet in a specific geographical location have viewed its ad.

It is a purpose of this invention to display this geographical location information on a map in real-time, along with additional real-time statistics on the price paid for ad impressions, and which advertising “strategies” win the most ad opportunities.

### SUMMARY OF THE INVENTION

The invention relates to an apparatus and method of processing information by computer. Collected data, which includes a visitor's IP address, and other visitor-related information obtained from the Internet, along with latitude and longitude coordinates of a visitor's geographical location are stored. The collected data are separated into two subsets, a per-advertiser data subset, and a per-site data subset. A site-viewpoint applet is transferred to a site Web page and an advertiser-viewpoint applet is transferred to an advertiser Web page on the Internet. Each applet is capable of processing a data subset to display, on a web page, indicia on a map, the indicia being located on the map according to geographical locations of Internet visitors. The per-site data subset is fed to the site-viewpoint applet and the per-advertiser data subset is fed to the advertiser-viewpoint applet, optionally in response to an authorized request received from a web page.

In accordance with an aspect of the invention, data are fed to an applet that includes a mapping component that displays each visitor's location on a map by plotting indicia at latitude/longitude coordinates on the map.

In accordance with an aspect of the invention, a visual characteristic of an indicium is changed in proportion to the number of Internet visitors from the same geographical location.

In accordance with an aspect of the invention, each indicium is a spot on the map that varies in at least one of color, size and intensity.

In accordance with an aspect of the invention, data fed to an applet may include running totals of performance data, a price histogram that plots the number of ads served at a given price, and a domain name moving “ticker tape” that displays, in real time, the domain names associated with visitors.

The invention has the advantage that a web advertiser can view, on its private advertiser web page, streaming data regarding every ad impression it placed in the marketplace, including the viewer's location, demographics, ad cost, etc. Site administrators can view, on a private site web page, streaming data regarding every ad impression transacted in the marketplace, including the viewer's location, demographics, ad cost, etc. The streaming data in either case is simultaneously shown on a map, bar and pie charts, with indicia positioned on the map according to geographical locations of Internet visitors.

The invention has the advantage that it aids an advertiser in targeting ads in cyberspace to a particular geographical location.

The invention has the advantage that if a particular State, Country or region was specified for ad placement, the advertiser can verify that the instructions for ad placement were followed.

### BRIEF DESCRIPTION OF THE DRAWINGS

The invention will be described in greater detail with reference to the drawings in which:

FIG. 1 is an overall block diagram of an ad electronic communication network (ECN) in which the present invention is embodied;

FIG. 2 is an overall block diagram of an ad server system in which the present invention is embodied;

FIG. 3 is a flow diagram of a servlet shown in FIG. 1 and FIG. 2;

FIG. 4 is a flow diagram of the site-specific applet shown in FIG. 1 and FIG. 2;

FIG. 5 is a flow diagram of the advertiser-specific applet shown in FIG. 1 and FIG. 2; and,

FIG. 6 is a representation of a window in which graphics generated in accordance with the teachings of the invention are displayed.

### DETAILED DESCRIPTION OF THE INVENTION

Overview

An ad server and geographical query provider (information provider) provide, in real time, an IP address, latitude and longitude coordinates of a visitor's geographical location, the domain name, the advertiser and ad, the site name, price paid for the ad and other visitor-related information. An advertising display server collects the data from the ad server and sorts the data into two caches, one containing a per-advertiser data subset (data selected from the advertiser's perspective), the other containing a per-site data subset (data selected from the site's perspective).

The advertising display server monitors the Internet for requests from site administrators and advertiser administrators. In response to a request, after validating log-in authenticity, a private web page is created for access by an authorized administrator, either a site administrator or an advertiser administrator, and a Java applet is attached to the private web page or a Java application is transferred to the client. Java is an object-oriented programming language used on the Web. A Java applet is a small program that can be sent along with a Web page to a user. Java applets can perform tasks without having to send a user request back to the advertising display server. The applet is capable of processing a data subset to dynamically display on the private web page indicia on a map. The indicia are located on the map according to geographical locations of the Internet visitors. In this specification “user-viewpoint applet” refers to either a site-viewpoint applet or an advertiser-viewpoint applet. It will be understood that other applets can be implemented to fit the specific needs of other users. It is also understood that the term “applet” as used herein includes a Java application that is run on the client to perform the same function.

Once log-in validation is confirmed, the advertising display server feeds the appropriate data subset to the appropriate applet. For example, if a request is from a site administrator, the site data subset is fed from the cache to the site-viewpoint applet. If a request is from an advertiser administrator, the advertiser data subset is fed from the cache to the advertiser-viewpoint applet.

The data are fed to an applet that includes a mapping component that displays each visitor's location on a map by plotting indicia at latitude/longitude coordinates on the map. The coordinates define map location information corresponding to the physical location of Internet visitors that have viewed the ad. Visual characteristics of indicia are changed in proportion to the number of Internet visitors from the same geographical location. For example, the indicia may be spots on the map that vary in color, size and/or intensity.

The data fed to an applet and displayed may also include running totals of performance data, a price histogram that plots the number of ads served at a given price, and a domain name moving “ticker tape” that displays, in real time, the domains from which visitors are coming or domains which visitors are accessing.

In this specification, a visitor is defined as a Web user with a unique IP address entering a Web site at some page for the first time that day or for the first time in a lesser or greater time period. The term “user” is defined as someone with authority to access a private Web page, such as a system administrator (site administrator, advertiser administrator, etc.) or someone accessing a non-private web page that does not require authorization.

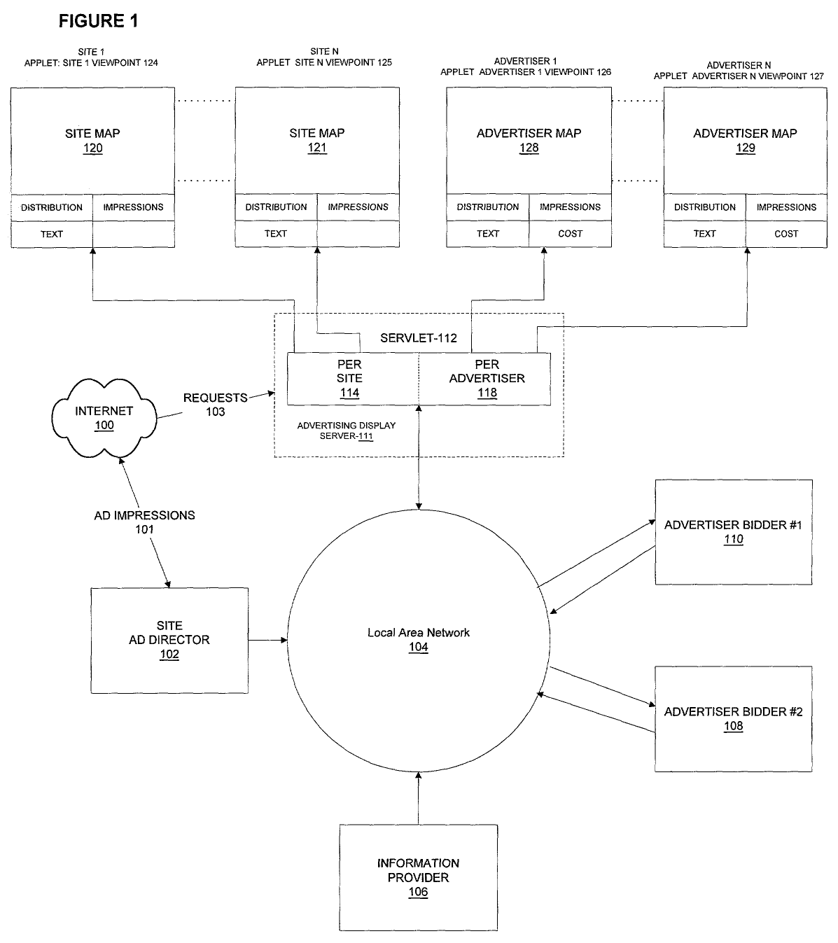

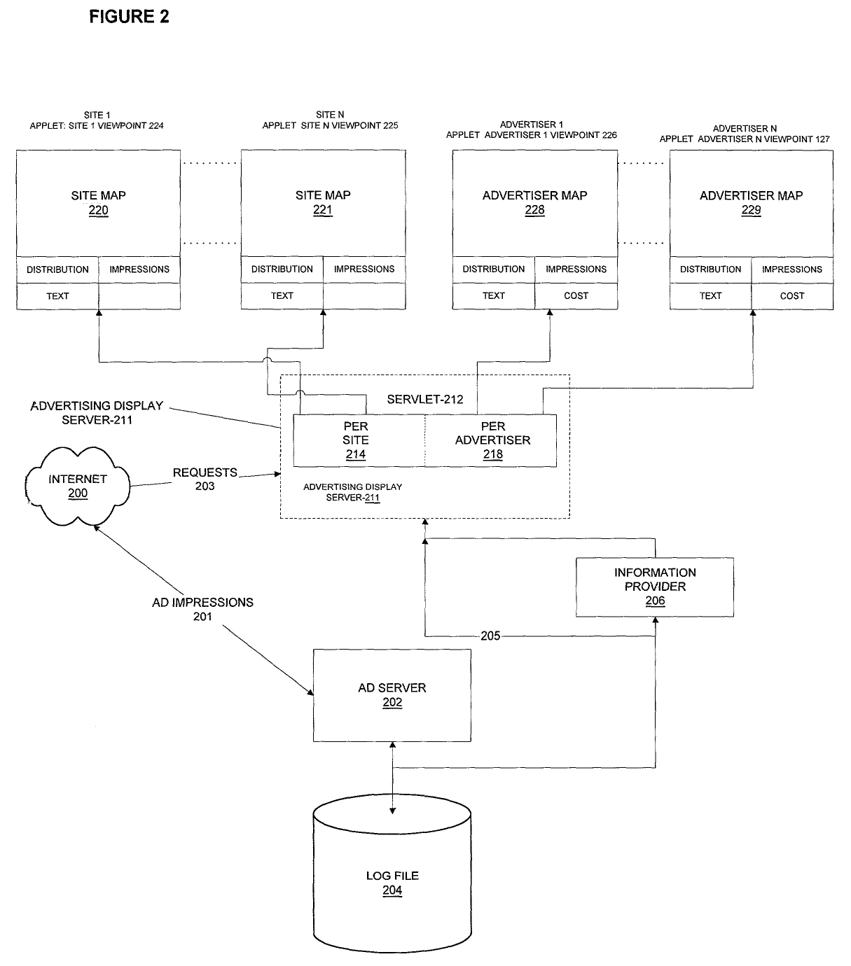

The invention will be described with respect to two systems in which the invention is embodied: an ECN with bidding protocol (FIG. 1) and a conventional ad server system (FIG. 2). It will be understood by those skilled in the art that the invention may be used in any Internet-based system that includes a web server, and any ad server, with or without a bidding protocol. It will also be understood that the invention may be embodied in a system in which ads are served into streaming media, such as video and audio.

ECN with bidding protocol (FIG. 1)

Refer to FIG. 1, which is an overall block diagram of an ad electronic communication network (ECN) with a bidding protocol as described in the above-referenced copending applications in which the present invention is embodied.

Advertisers advertise their products and services on web pages on the Internet 100 by banner ads that are graphical representations of products and services being offered. In Web advertising, the term impression is used to refer to an ad view. Advertisers buy advertising measured in terms of ad views or impressions. A single Web page may contain multiple ads; hence a site may register more ad views per unit of time than Web pages per unit of time. Page impressions are logged in a log that is maintained by the site server. Currently available programs can read the log and generate reports about site usage. Other currently available programs can keep track of all ad impressions that have been sent and how many of these were clicked on by visitors to a Web site. “Banner Advertisement Impression” is currently defined as a single display or impression of an image or HTML file (animated, interlaced or static), hyperlinked to an advertiser's web page. However, it will be understood that the term “Impression” may also include video ads or programming viewed from the equivalent of a Web site or other interactive resource on a computer screen or a television screen.

When someone browsing a web page (a visitor) clicks on an ad, a link causes a transfer to the advertisers web page. Web sites allow advertisers to advertise on web pages for a fee. For example, the advertiser may be charged a fixed fee for every thousand times its banner ad is served up on a web page, called cost per thousand (CPM).

Computers associated with an information provider 106, site ad director 102, and advertiser bidders 108, 110, communicate with each other over a communication network, such as local area network (LAN) 104 to which the computers are attached. The information provider 106 includes a geographical query provider that provides geographical information as to the location of Internet visitors.

The Site Ad Director 102 monitors Internet traffic and sends ad impressions to visitors via the Internet 100. The site ad director assembles information about visitors who have visited web sites having web page space displaying banner ads and places visitor data on the LAN 104.

The information provider 106 receives the visitor data and adds additional data that supplies an ID of a visitor in response to a query. The information provider adds geographical location information (e.g. the latitude and longitude coordinates) of the visitor to the ad impression data, resulting in enhanced data. The enhanced data are placed on the LAN 104. The enhanced data includes the IP address of the visitor, the location (latitude and longitude), the domain name, the advertiser/ad, the site, the price, and other visitor-related information.

Advertiser bidder # 1 and advertiser bidder # 2 provide bidder interfaces, 108, 110, to the local area network (LAN). Bidders # 1 and bidder # 2 upload information supplied by the site ad director 102 and the Information provider 106 from the LAN. Each bidder implements its own individualized advertising campaign that may employ a number of bidding strategies. The bidding strategies can include a number of parameters, such as opt-in, age, and location, which are described below. The strategies are used in conjunction with the information uploaded from the LAN to determine for which ad space on a participating web site the bidder wants to bid.

Opt-in: Opt-in e-mail is a Web marketing term for promotional e-mail that recipients have previously requested by signing up for promotional information about one or more categories of products or services. Those who sign up have thus “opted in.” Anyone sending them e-mail as a result expects that the message will not be perceived as unwanted. Several companies gather sign-ups at their own site or through specially designed banner ads and then sell marketers mailing lists of those who have signed up in various interest categories. The opt-in strategy provides options based on interests such as visitors that have expressed interest in information about computers, arts and crafts, business, food, etc. with a bid per option expressed in CPM.

Location: this strategy provides parameters for visitor location, latitude and longitude expressed in degrees; radius in miles; price inside or outside, with a bid expressed in CPM, domain address and ZIP code.

Age: expressed in years between a maximum and minimum age and CPM, greater than, less than or equal to a certain number.

The servlet 112 of FIG. 1 is a program running on an advertising display server 111 that directs a data stream received from the LAN to the relevant site viewpoint applet 124 or advertiser viewpoint applet, 126. A servlet is a small program that runs on a server. The servlet can be implemented with the Java programming language. The advantage of a Java servlet on the advertising display servers is that it can execute more quickly than CGI applications. The ad impression and geographical information is received from the LAN and recorded in per site and per advertiser hash tables. Hashing is the transformation of a string of characters into a usually shorter fixed-length value or key that represents the original string. Hashing is used to index and retrieve items in a database because it is faster to find the item using the shorter hashed key than to find it using the original value. Each hash table is an index created by a hashing algorithm that generates a hash value, which indicates the ordered position of an item.

The servlet 112 separates the enhanced data into user-specific data, such as site-specific data 114 and advertiser-specific data 118. The site-specific data 114 and a site-specific applet are transferred to a private web page accessible to the site. The site-specific applet is capable of dynamically plotting indicia representing ad impressions for a site included in the site-specific data on a map 120 on the private web page accessible to the site. A visual characteristic of an indicium such as color, size and/or intensity is changed in proportion to the number of the Internet visitors from the same geographical location.

The advertiser-specific data 118 and an advertiser-specific applet are transferred to a private web page accessible to the advertiser. The advertiser-specific applet can dynamically plot, on a map, 128 indicia representing ad impressions for the advertiser included in the advertiser-specific data. A visual characteristic of an indicium such as color, size and/or intensity is changed in proportion to the number of the Internet visitors from the same geographical location.

Conventional Ad Server System (FIG. 2)

Refer to FIG. 2, which is an overall block diagram of a conventional ad server system in which the present invention is embodied.

When someone browsing a web page (a visitor) clicks on an ad, a link causes a transfer to the advertisers web page.

Computers associated with Information provider 206, site ad server 202, communicate with each other over a network 205 to which the computers are attached.

An Ad Server 202 monitors Internet traffic and sends ad impressions 201 directly to a visitor via the Internet 200. The ad server 202 transfers the visitor data related to ad impressions to a log file 204 and Information provider 206.

The Information provider 206 provides data that includes an ID of a visitor, in response to a query. The Information provider adds geographical location information (e.g. the latitude and longitude coordinates) of the visitor to the ad impression data, resulting in enhanced data. The enhanced data, which now includes ad impression data, a visitors ID, and geographical data, are placed on the bus 205. The enhanced data includes the IP address of the visitor, the location (latitude and longitude), the domain name, the advertiser/ad, the site, the price, and other visitor-related information.

The servlet 212 of FIG. 2 is the same as that described with reference to FIG. 1. It is a program running on an advertising display server 211 that directs a data stream received from the network 205 to the relevant site viewpoint applet 224 or advertiser viewpoint applet 226. The ad impression and geographical information is received from the network 205 and recorded in per site and per advertiser hash tables.

The servlet 212 separates the enhanced data into user-specific data, such as site-specific data 214 and advertiser-specific data 218. The site-specific data 214 and a site-specific applet are transferred to a private web page accessible to the site administrator. The site-specific applet can dynamically plot, on a map 220, indicia representing ad impressions for a site included in the site-specific data. A visual characteristic of an indicium such as color, size and/or intensity is changed in proportion to the number of the Internet visitors from the same geographical location.

The advertiser-specific data 218 and an advertiser-specific applet are transferred to a private web page accessible to the advertiser, the advertiser-specific applet being capable of dynamically plotting indicia representing ad impressions for the advertiser included in the advertiser-specific data on a map 228 on the private web page accessible to the advertiser. A visual characteristic of an indicium such as color, size and/or intensity is changed in proportion to the number of the Internet visitors from the same geographical location.

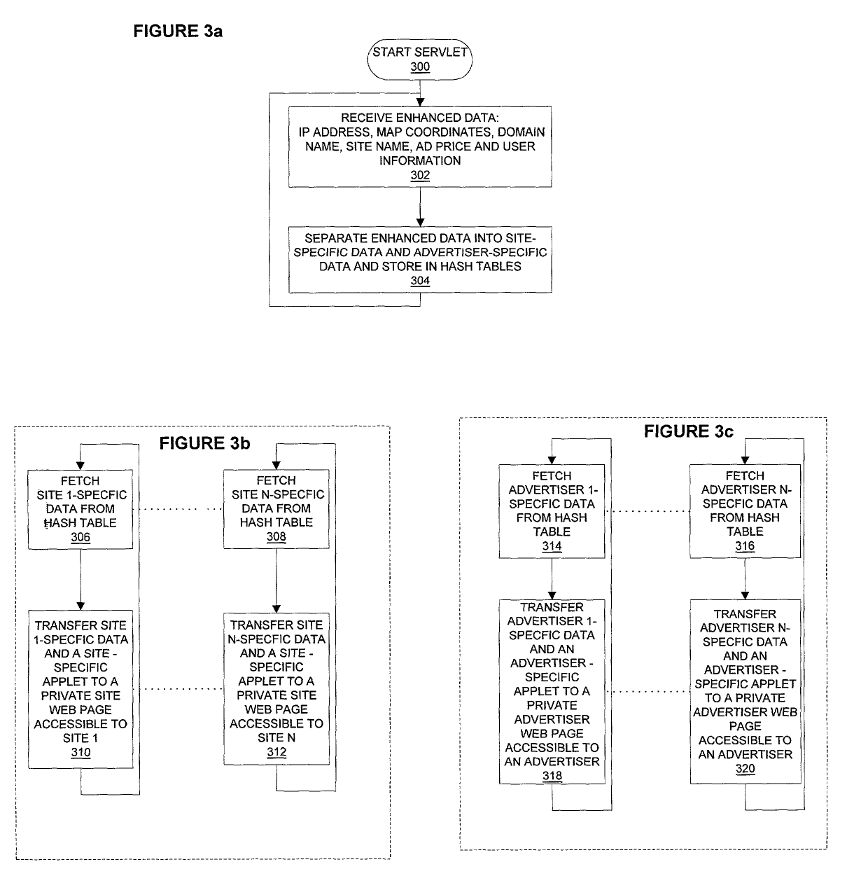

Refer to FIGS. 3a, 3b and 3c, which comprise flow diagrams of the servlet 112 shown in FIG. 1 and servlet 212 shown in FIG. 2. The servlet program starts 300 (FIG. 3a). At 302 the servlet receives enhanced visitor data. The enhanced data includes ad impressions, IP addresses of visitors and geographical data including locations of IP addresses of the visitors. At step 304 the servlet separates the enhanced data into site-specific data and advertiser-specific data.

In FIG. 3b, at 306, 308, the site-specific data (1−N) are fetched. At 310, 312, the site-specific data (1−N) and a site-specific applet for each site 1−N are transferred to private web pages 1-N accessible to the corresponding site.

In FIG. 3c, at 314, 316, the site-specific data (1−N) are fetched. At 318,0320 the advertiser-specific data and an advertiser-specific applet for each site 1−N are transferred to private web pages 1−N accessible to the corresponding advertiser.

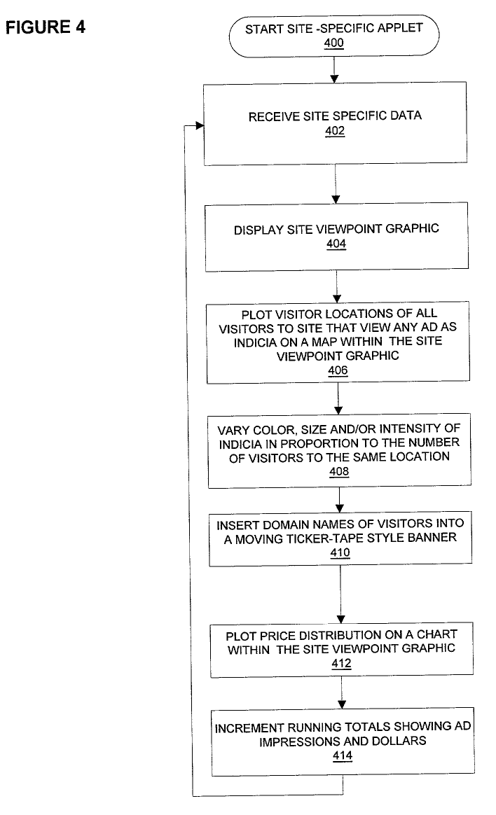

Refer to FIG. 4, which is a flow diagram of the site-specific applet 124 shown in FIG. 1 and 224 shown in FIG. 2. The Site Viewpoint applet is a small program attached to the site viewpoint web page activated while the page is being viewed to display the site viewpoint graphic. The site-specific applet starts 400. Site specific data are received 402. Visitor locations of all visitors to this site that view any ad are plotted as indicia on a map within the site viewpoint graphic 406. The color, size and/or intensity of indicia are varied in proportion to the number of visitors to the same location 408. Domain names of visitors are inserted into a moving ticker-tape style banner 410. Price distribution is plotted on a chart within the site viewpoint graphic 412.

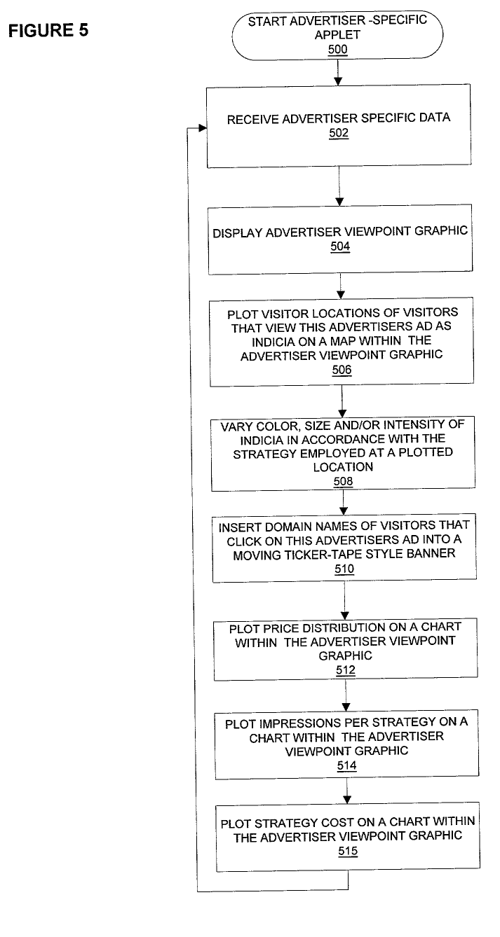

Refer to FIG. 5, which is a flow diagram of the advertiser-specific applet 126 shown in FIG. 1 and 126 shown in FIG. 2. The Advertiser Viewpoint applet is a small program attached to the advertiser viewpoint web page activated while the page is being viewed to display the advertiser viewpoint map. The advertiser-specific applet starts 500. Advertiser-specific data are received 502. Visitor locations of visitors to this site that view an ad of this advertiser are plotted as indicia on a map within the advertiser viewpoint graphic 506. The color, size and/or intensity of indicia are varied in proportion to the strategy employed by the advertiser at the visitor's location 508. Domain names of visitors are inserted into a moving ticker-tape style banner 510. Price distribution is plotted on a chart within the advertiser viewpoint graphic 512. Impressions per strategy are plotted on a chart within the advertiser viewpoint graphic 514. Strategy cost is plotted on a chart within the advertiser viewpoint graphic 515.

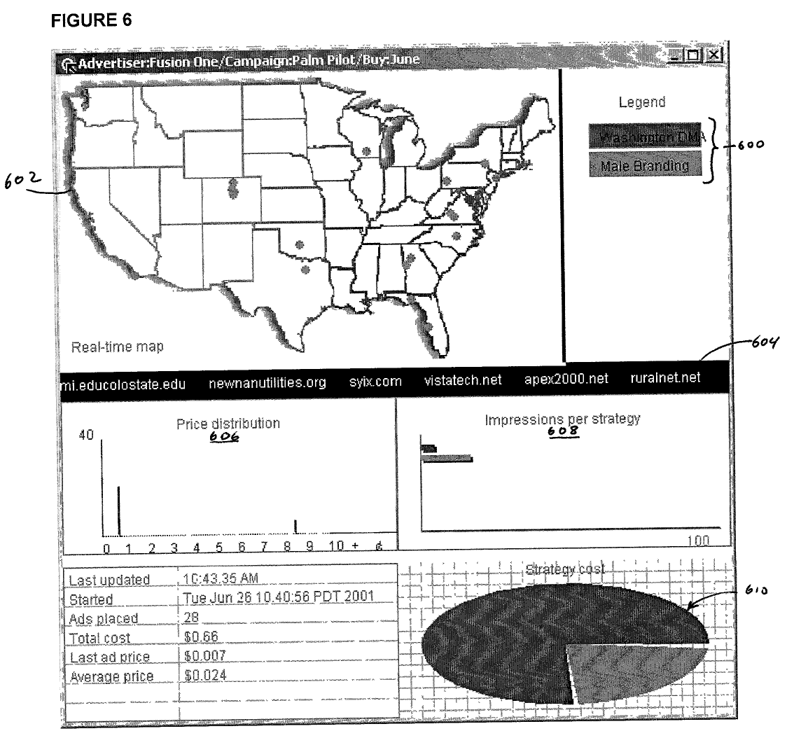

Refer to FIG. 6, which is a representation of a window in which graphics generated in accordance with the teachings of the invention are displayed. A bidder with the advertising strategies shown in the legend 600 bids for ad space on Web sites. If the bids are successful, ad impression data are returned which results in the Real-time map 602, which displays the graphical locations of the visitors viewing ads. Each strategy is displayed as a different color on the map. As Internet visitors enter sites where ads are placed, a ticker-bar 604 shows in real-time the domain name of that visitor. The price distribution bar chart 606 displays the number of ad impressions versus price (cents) and changes with time and as the strategies are changed. It shows a distribution of what was paid per ad. The impressions per strategy bar chart 608 displays the number of ad impressions per strategy (opt-in, age, and location). The strategy cost pie chart 610 illustrates the cost per strategy as a percentage of the total cost.

The invention has been described with reference to a web page media format wherein elements of a web page are usually displayed one screen-full at a time. The teachings of the invention are applicable to other media formats such as streaming video or streaming audio.

While the invention has been particularly shown and described with reference to preferred embodiments thereof, it will be understood by those skilled in the art that the foregoing and other changes in form and detail may be made therein without departing from the scope of the invention.

What is claimed is:

1. For use with the Internet, a system comprising:
A communication network;
An ad server;
An information provider; and,
An advertising display server;
Said ad server, information provider and advertising display server being connected to said communication network;
Said ad server having stored therein, a visitor's IP address, and other visitor-related information;
Said information provider having stored therein latitude and longitude coordinates of a visitor's geographical location;
Said advertising display server having stored in two caches, data subsets separated from data collected from said ad server and said information provider, a first of said caches having stored therein a per-advertiser data subset, a second of said caches having stored therein a per-site data subset.

2. The system of claim 1 wherein said advertising display server has stored therein a site-viewpoint applet and an advertiser-viewpoint applet, each applet capable of processing a data subset to display on a web page indicia on a map, said indicia being located on the map according to geographical locations of Internet visitors.

3. The system of claim 2 wherein said advertising display server includes a servlet capable of selectively feeding said per-site data subset from said first cache to said site-viewpoint applet and said per-advertiser data subset from said second cache to said advertiser-viewpoint applet.

4. The system of claim 3 wherein data fed to an applet may include a mapping component that displays each visitor's location on a map by plotting indicia at latitude/longitude coordinates on the map.

5. The system of claim 2 wherein a visual characteristic of an indicium is changed in proportion to the number of Internet visitors from the same geographical location.

6. The system of claim 5 wherein, said indicium is a spot on the map that varies in at least one of color, size and intensity.

7. The system of claim 1 wherein data fed to an applet may include running totals of performance data, a price histogram that plots the number of ads served at a given price, and a domain name moving “ticker tape” that displays, in real time, the domain names associated with visitors.

8. A method of processing information by computer comprising steps of:
A. Storing collected data which includes a visitor's IP address, and other visitor-related information, said collected data further including latitude and longitude coordinates of a visitor's geographical location;
B. Separating said collected data into two subsets, a per-advertiser data subset, and a per-site data subset;
C. Transferring to either a web page on said internet or a server, a site-viewpoint applet and an advertiser-viewpoint applet, each applet capable of processing a data subset to display, on a web page, indicia on a map, said indicia being located on said map according to geographical locations of Internet visitors; and,
D. Selectively feeding said per-site data subset to said site-viewpoint applet and said per-advertiser data subset to said advertiser-viewpoint applet.

9. The system of claim 8 wherein data fed to an applet may include a mapping component that displays each visitor's location on a map by plotting indicia at latitude/longitude coordinates on the map.

10. The system of claim 9 wherein a visual characteristic of an indicium is changed in proportion to the number of Internet visitors from the same geographical location.

11. The system of claim 10 wherein said indicium is a spot on the map that varies in at least one of color, size and intensity.

12. The system of claim 8 wherein data fed to an applet may include running totals of performance data, a price histogram that plots the number of ads served at a given price, and a domain name moving “ticker tape” that displays, in real time, the domain names associated with visitors.

13. For use on an Internet user web page accessible to a user, a program comprising steps of:
A. Receiving user-specific data related to visitors of Internet web sites upon which ads have been placed on a public web page accessible to Internet Web page visitors, said ads having been placed in accordance with an ad campaign strategy of an advertiser;
Said user-specific data including ad impressions, IP addresses of visitors and geographical data including locations of IP addresses of said visitors; and,
B. Plotting indicia representing ad impressions for a site included in said user-specific data on a map on a private web page.

14. The method of claim 13 wherein a visual characteristic of said indicia is changed in proportion to a number of said Internet visitors from the same geographical location.

15. The method of claim 14 wherein said visual characteristic is at least one of (1) color (2) size and (3) intensity.

16. A method comprising steps of:
A. Receiving enhanced data related to visitors of Internet web sites upon which ads have been placed on a public web page accessible to Internet visitors, said ads having been placed in accordance with an ad campaign strategy of an advertiser;
Said enhanced data including ad impressions, IP addresses of visitors and geographical data including locations of IP addresses of said visitors;
B. Separating said enhanced data into user-specific data; and,
C. Transferring said user-specific data and a user-viewpoint applet to a private web page accessible to said user;
Said user-viewpoint applet capable of plotting indicia representing ad impressions for a site included in said user-specific data on a map on said private web page.

17. The method of claim 16 wherein a visual characteristic of said indicia is changed in proportion to a number of said Internet visitors from the same geographical location.

18. The method of claim 17 wherein said visual characteristic is at least one of (1) color (2) size and (3) intensity.

19. The method of claim 16 wherein said user-specific data are one of a site-specific data or an advertiser-specific data. .

20. The method of claim 16 wherein said user-viewpoint applet is one of a site-viewpoint applet or an advertiser-viewpoint applet.
